(19) United States
(12) Patent Application Publication
(10) Pub. No.: US 2012/0150548 A1
(43) Pub. Date: Jun. 14, 2012

(54) BUSINESS APPLICATION LIFECYCLE MANAGEMENT

(75) Inventors: Balasubramanian Rajagopalan, Hyderabad (IN); Rajat Talwar, Gurgaon (IN); Mustansir Kaizer Doctor, Hyderabad (IN); Sai Shankar, Hyderabad (IN); Tapas Kumar Nayak, Hyderabad (IN)

(73) Assignee: MICROSOFT CORPORATION, Redmond, WA (US)

(21) Appl. No.: 12/967,403

(22) Filed: Dec. 14, 2010

(51) Int. Cl. G06Q 10/00

(52) U.S. Cl. 705/1.1

(57) ABSTRACT

The subject disclosure relates to lifecycle management for business models associated with a business application as well as implementations of the business models. As described herein, a framework is provided in which business models can be built using modeling tools. The framework defines a separation of models from implementations and their relationships. Support is provided for translation of a business model to an implementation automatically and/or manually using development tools. Further embodiments herein define relationships of models to their implementations at various levels of granularity. Relationships can be defined and maintained at various granularity levels of a business application with different addressable granularity of an implemented application. These relationship associations can be used as described herein for tracking and managing changes in an implementation that may affect an associated model and vice versa.

### TECHNICAL FIELD

The subject disclosure relates to computing system management of lifecycles of models within a computing system and their implementations.

### BACKGROUND

A business application comprises one or more business models, which can include process models, analytic models, rules, and the like. These business models are created and saved using various modeling tools upon which the models can be implemented using a variety of existing applications. Conventionally, business applications include one or more related models and, optionally, partial or full implementations of the respective models. Additionally, business applications can go through a governance step in which their constituent models and changes to such models are reviewed by appropriate authorities, executives, etc., and approved or denied. Subsequent to approval, the business application is published, and the constituent models of the published business application and their respective implementations are then validated for completeness and consistency.

In a conventional business application management system, business applications are observed and monitored by a business user at the model level. However, it would be desirable to implement an improved framework for defining and managing lifecycle of business applications through authoring, validation, governance, implementation and changes.

The above-described deficiencies of today's application management techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, a framework is provided in which business models can be built using any suitable modeling tools. The framework defines a separation of models from implementations and their relationships. Support is provided for translation of a business model to an implementation automatically and/or manually using development tools. Further, various embodiments herein support business models associated with zero or more implementations at a given time.

Further embodiments herein define relationships of models to their implementations at various levels of granularity. For example, business applications as defined herein as associated with granularity levels of business applications, models, business artifacts, and the like. Relationships can be defined and maintained at various granularity levels of a business application with different addressable granularity of an implemented application. In the event that an implementation is conducted as a composite application, the addressable granularity levels of implementation include application, module, component, resource and artifact. These relationship associations can be used as described herein for tracking and/or managing changes in an implementation that may affect an associated model and vice versa. In addition, the framework enables incremental complexity on the model resulting in incremental value realization, thereby increasing ease of use in relation to conventional systems where the barrier of entry for business users presents a steep learning curve associated with modeling notations and languages.

These and other embodiments are described in more detail below.

### BRIEF DESCRIPTION OF THE DRAWINGS

Various non-limiting embodiments are further described with reference to the accompanying drawings in which:

FIG. 1 is a block diagram showing a simplified view of a business application lifecycle management system in accordance with one or more embodiments;

FIG. 2 is an illustrative view of an exemplary business application structure in accordance with one or more embodiments;

FIG. 3 is an illustrative view of an exemplary business application lifecycle in accordance with one or more embodiments;

FIG. 4 is a state diagram showing a business application lifecycle management procedure in accordance with one or more embodiments;

FIGS. 5-6 are block diagrams showing respective exemplary application management systems in accordance with one or more embodiments;

FIG. 7 is an illustrative view of an exemplary model-to-implementation mapping in accordance with one or more embodiments;

FIG. 8 is a block diagram showing a business model editing management system in accordance with one or more embodiments;

FIG. 9 is a flow diagram illustrating an exemplary non-limiting process for business application lifecycle management;

FIG. 10 is another flow diagram illustrating an exemplary non-limiting process for business model governance, deployment and editing control;

FIG. 11 is a block diagram representing exemplary non-limiting networked environments in which various embodiments described herein can be implemented; and

FIG. 12 is a block diagram representing an exemplary non-limiting computing system or operating environment in which one or more aspects of various embodiments described herein can be implemented.

### DETAILED DESCRIPTION

### Overview

By way of introduction, a framework is described herein that provides a framework for defining business object models. Business object models define an abstract business object, such as orders, customers, or the like, in a way that a typical business user can define and comprehend. In one example, business objects additionally include fields. Field names are not restricted to programming language field names, and can be text and in any locale (e.g., language, character set, etc.) appropriate for the business users associated with the business objects. In another example, business objects can be combined in a relationship to define a composite business object. Further, other business models, such as rules, key performance indicators (KPIs), processes, or the like, can refer to these business object models to express the intent of the business user. In an additional example, business objects can be versioned.

In an embodiment, a business application includes one or more business models. For instance, a business application may include process models, KPI definitions, business rules, business object models, etc. A model can be realized using a modeling tool (e.g., a diagramming tool, spreadsheet tool, word processor, etc.), and the relevant resources generated (e.g., files) are defined as the artifacts associated with the models. In one example, a business application defines a package of relevant models and associated artifacts.

In accordance with various embodiments herein, described are mechanisms for relating respective business models with their implementations, based on which lifecycle management can be conducted for business models as well as their implementations. In addition, mechanisms are described herein for editing control of business models and implementations, implementation selection and creation, and other relevant procedures.

In one embodiment, a business application lifecycle management system includes an application modeling component configured to facilitate construction of a business application as one or more business models and a lifecycle management component configured to associate the one or more business models with respective implementations and to track lifecycles of the one or more business models and the respective implementations.

In some implementations, the application modeling component is further configured to facilitate construction of respective business models of the one or more business models as sets of artifacts. In other implementations, the application modeling component includes a business model creation component that facilitates construction of the one or more business models, and the system additionally includes an implementation creation component that facilitates creation of the respective implementations of the one or more business models.

In another example, the system includes a business model authoring component configured to facilitate authoring of the one or more business models and a business model governance component configured to define an approval process for the one or more business models, wherein the one or more business models are deemed ready for deployment in response to approval.

In a further example, the system includes a business model store configured to store one or more approved business models. Additionally or alternatively, the system can include a business model browser configured to facilitate selection of one or more approved business models from the one or more approved business models stored by the business model store. The system can also include a code development component configured to facilitate creation of code corresponding to an implementation of at least one approved business model and a model import component configured to facilitate importation of the at least one approved business model from the business model store.

In still other implementations, the lifecycle management component includes a model-implementation state management component that tracks lifecycle states with reference to relationships between a business model of the one or more business models and a deployed implementation for the business model of the one or more business models. Additionally or alternatively, the system can include an application model store configured to store data relating to at least one implemented business application.

In one example, at least one business model of the one or more business models is associated with a plurality of implementations and the lifecycle management component is configured to track lifecycle of at least one selected implementation corresponding to the at least one business model of the one or more business models. In another example, the one or more business models include at least one of business object models (BOMs), process models, tracking models, or rules models. A BOM can represent, e.g., at least one of entities or events. In a further example, the system can further include a model locking component configured to lock a business model to a read-only mode in response to deployment of the business model.

In another embodiment, a method for managing lifecycle of a business application includes defining a business application as one or more business models, associating business models of the one or more business models with respective model implementations, and tracking lifecycles of the one or more business models and the model implementations respectively associated with the one or more business models.

In one example, the method further includes authoring respective business models of the one or more business models and approving the respective business models of the one or more business models for deployment via a governance process. Additionally or alternatively, the method can further include developing the model implementations respectively associated with the one or more business models and importing the one or more business models into the model implementations.

In another example, the method includes locking the one or more business models to a read-only state in response to deployment of the one or more business models. In response to undeployment of the one or more business models, the method can also include returning the one or more business models to a writeable state. In a further example, the tracking includes identifying a plurality of model implementations associated with at least one business model of the one or more business models and tracking lifecycle of a selected model implementation from the plurality of model implementations.

In an additional embodiment, a system that facilitates management of a business application lifecycle includes means for constructing a business application comprising one or more business models, the one or more business models respectively comprising at least one artifact, means for identifying relationships between the one or more business models and implementations of the one or more business models, and means for managing lifecycles of the one or more business models and the implementations of the one or more business models with reference to the relationships between the one or more business models and implementations of the one or more business models.

Herein, an overview of some of the embodiments for achieving scope creation and termination in a computing system has been presented above. As a roadmap for what follows next, various exemplary, non-limiting embodiments and features for distributed transaction management are described in more detail. Then, some non-limiting implementations and examples are given for additional illustration, followed by representative network and computing environments in which such embodiments and/or features can be implemented.

### Business Application Lifecycle Management

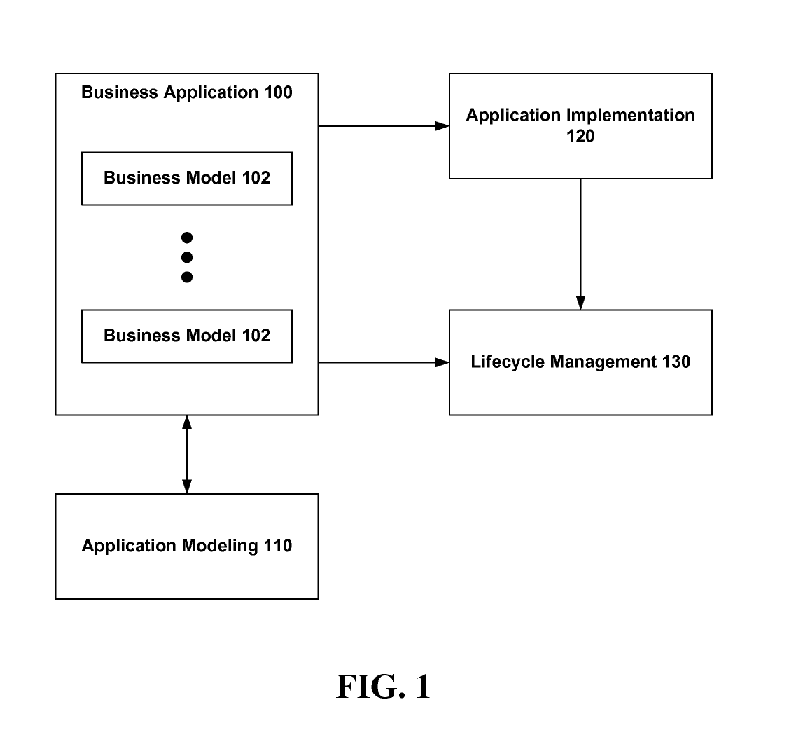

By way of further description with respect to one or more non-limiting ways to conduct lifecycle management of one or more applications associated with a computing system, a block diagram of an exemplary business application lifecycle management system is illustrated generally by FIG. 1. The system illustrated by FIG. 1 includes a business application 100, which is composed of one or more business models 102. Business application 100 and/or its constituent business models 102 are authored via an application modeling component 110. Further, the business application is implemented via an application implementation component 120. Application implementation component 120 can leverage one or more mechanisms to facilitate implementation of business application 100, such as, e.g., collaboration applications, composite applications, Java platform applications, etc.

As further shown by FIG. 1, a lifecycle management component 130 can be utilized to manage the lifecycles of both business application 100 and its implementation(s), as realized by application implementation component 120. In an embodiment, lifecycle management component 130 relates business models 102 and/or their corresponding business application(s) 100 to respective implementations. By providing relationships and/or other associations between models and their implementations, lifecycle management component 130 is able to provide improved management of the lifecycle of business application 100. For example, if an issue is detected within a business application 100, knowledge of the relationships between models and implementations enable location of an entity that owns the implementation at issue. Further, if a model at issue is represented by a business rule and a change to the model is desired, knowledge of the relationships between models and implementations enable an application developer to access the implementation directly from the model in order to change the implementation.

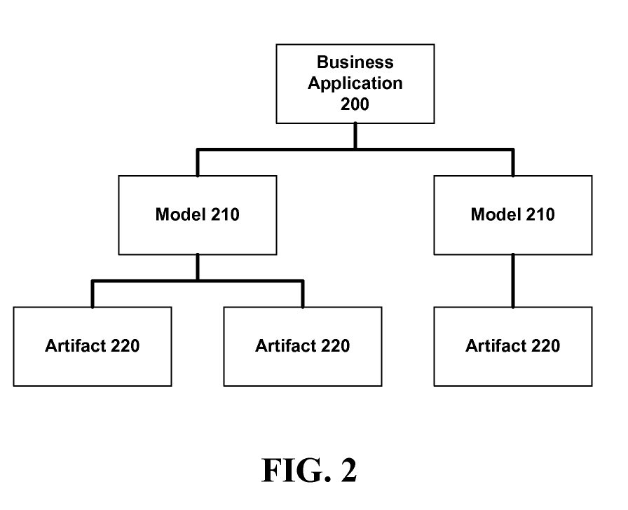

In one example, lifecycle management component 130 can define a business application structure to facilitate lifecycle management operation. For example, as illustrated by FIG. 2, a business application 200 can be defined as including one or more models 210, each of which in turn can include respective artifacts 220. Artifacts 220 can correspond to, for example, respective files and/or other items constructed for a model 210 in a word processor, spreadsheet application, diagramming application, presentation suite, and/or any other suitable authoring application(s).

Returning to FIG. 1, lifecycle management component 130 can leverage the business application structure illustrated by FIG. 2 to relate respective business models 102 corresponding to a business application 100 to various portions of the implementation of the business application 100 as realized by application implementation component 120 that realize the respective business models 102. For example, a business application 100 can be implemented by application implementation component 120 as a set of modules and/or other code segments, which can be respectively associated with different business models 102 associated with the business application 100 as appropriate. Additionally or alternatively, lifecycle management component 130 can define various business models 102 and/or implementation segments provided by application implementation component 120 to each other.

By way of specific, non-limiting example of the above, a business application 100 can be authored in which one workflow performs inventory verification, another workflow performs order validation, and a third workflow computes shipping costs. Application implementation component 120 can then be utilized to provide various modules that implement respective portions of the business application 100. Accordingly, lifecycle management component 130 can track the modules that implement respective portions of the business application 100 and its corresponding business models 102. Further, given the stage at which a given business model 102 is implemented, lifecycle management component 130 can be further configured to track stages of the implementation(s) that realize the business model 102. In addition, lifecycle management component 130 can be configured to track the relationships between respective business models 102 corresponding to the business application 100 and the implementations that realize them.

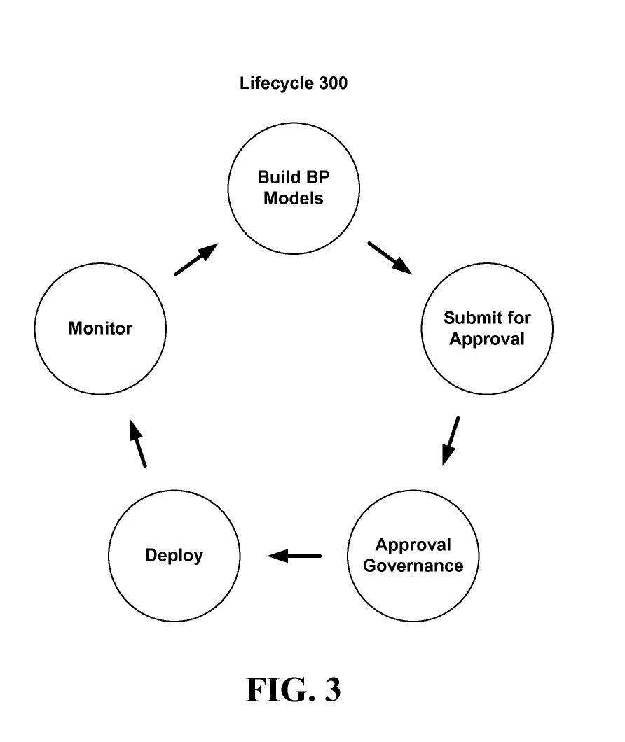

In an embodiment, lifecycle management component 130 can manage a lifecycle that is structured in a similar manner to lifecycle 300 in FIG. 3. As shown by FIG. 3, lifecycle 300 begins with authoring and/or other building of a business process (BP) model. The model is submitted for approval upon completion, at which time the model undergoes an approval governance process. The model can be returned for modification or approved as a result of the governance process. If approved, the model is deployed and monitored. If changes to the model are subsequently desired after deployment, the model lifecycle returns to the building stage to repeat the above process.

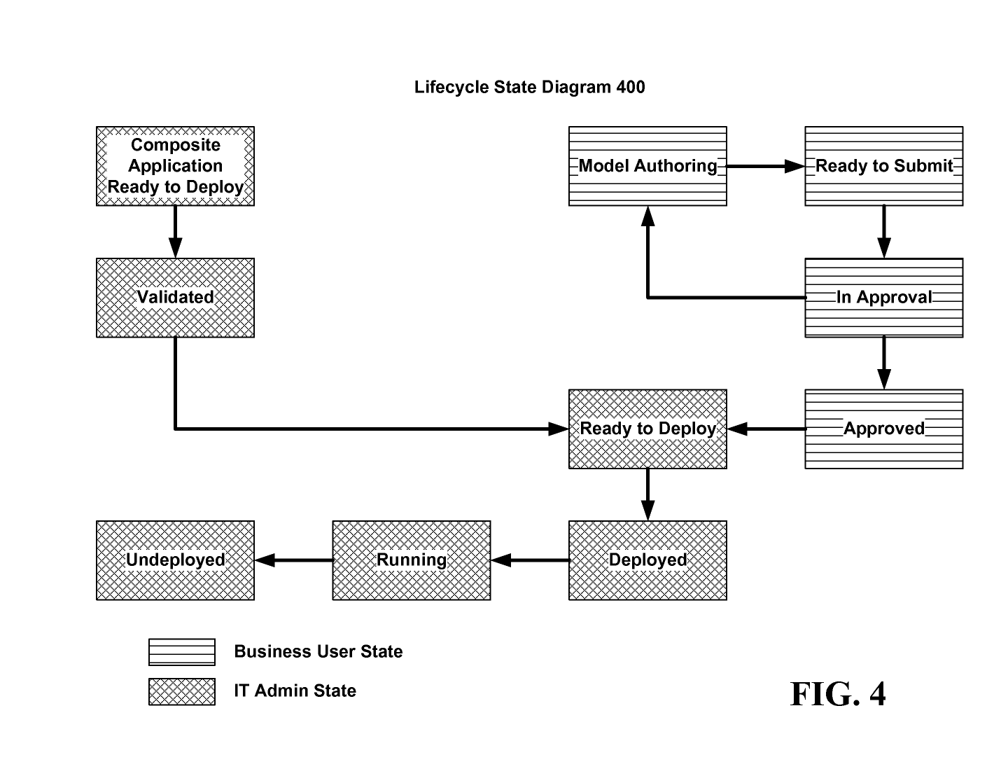

In another embodiment, a lifecycle management system as described herein can operate according to lifecycle state diagram 400 in order to manage the lifecycle of a business model in addition to its implementation(s). As shown by FIG. 4, various states of lifecycle state diagram 400 are implemented by a business user (BU) and/or an information technology (IT) administrator, although it can be appreciated that other entities can realize some or all of the illustrated states.

As lifecycle state diagram 400 illustrates, a BU can author a business model, which can be based on a business application. Upon completion of authoring, the model is ready to submit, and it is submitted for an approval process. While in approval, the model can be returned to authoring for modifications or approved. Once In the approval state, the model remains an approved model until it is deployed and/or implemented.

As further shown by lifecycle state diagram 400, an IT administrator obtains information relating to a composite application that is ready to deploy by, for example, identifying models, artifacts, etc., in the composite application. In addition, associations between the models, artifacts, etc., of the composite application and respective implementations are identified. Next, the composite application enters a validation phase, wherein it is verified that the constraints of the associations between the models of the composite application and its implementations will be satisfied by the implementations. Upon successful validation, the composite application is deemed ready to deploy.

As additionally illustrated by lifecycle state diagram 400, the lifecycle states for a model and its implementation are joined at the ready to deploy phase. Thus, the model as well as its implementation are jointly deployed, monitored, and undeployed as desired. As a result, it can be appreciated that lifecycle management as described herein relates a model to its implementation by relating the model authoring process to the implementation process, thereby providing improved lifecycle management of the associated business application. For example, some conventional techniques attempt to automatically relate an implementation to a model. However, once an implementation is obtained for a given model, such techniques do not provide mechanisms by which lifecycles of both the model and its implementation can be managed. In addition, in contrast to conventional techniques, the lifecycle management techniques described herein can operate both for automated and manual model-to-implementation relations.

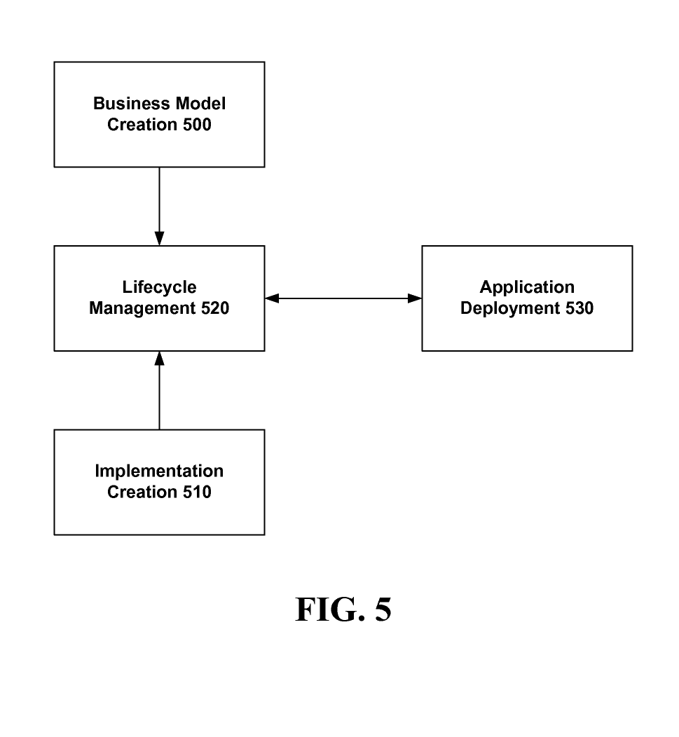

Turning next to FIG. 5, an exemplary application management system is illustrated. The system includes a business model creation component 500, which can include one or more word processors, spreadsheet tools, diagramming tools, and/or other suitable means for constructing a business model. The system can further include an implementation creation component 510, which can include one or more development tools for creating an implementation of a business model. In an embodiment, a lifecycle management component 520 is utilized to relate the business model created via business model creation component 500 and one or more implementations created via implementation component 510 and to manage their respective lifecycles, including deployment via an application deployment component 530.

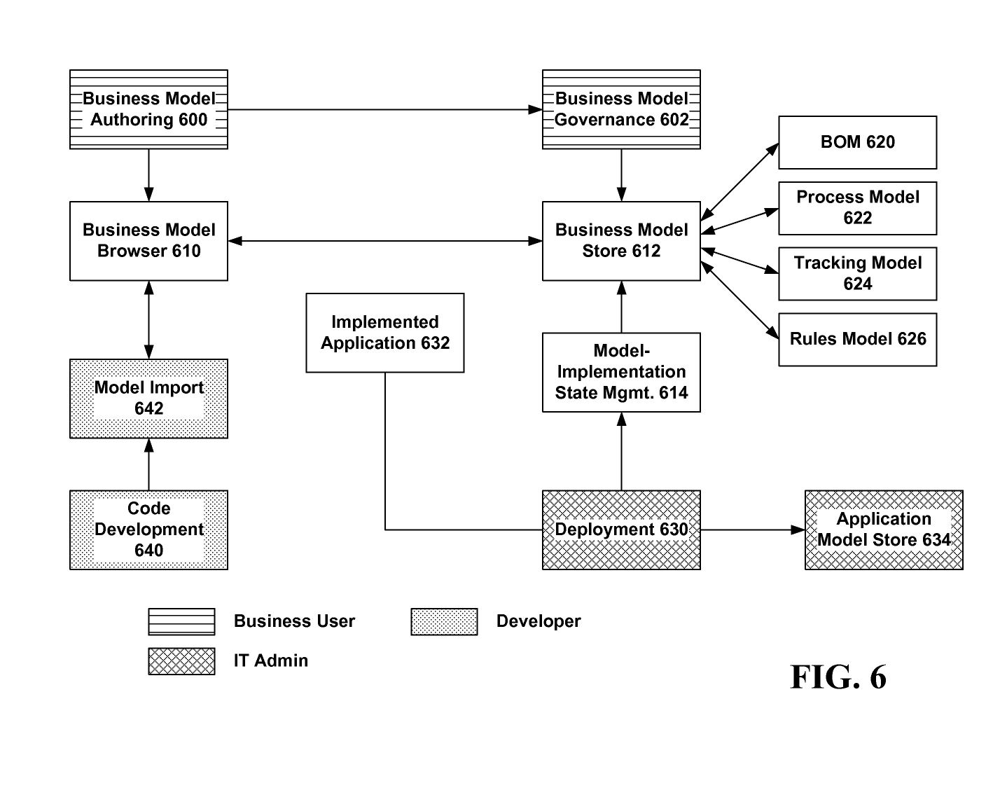

In another embodiment, a system that can be utilized to develop and manage applications in a computing system is illustrated by FIG. 6. As shown in FIG. 6, a business user can utilize a business model authoring component 600 to create a business model. Upon creation of a business model, the business model and/or its constituent business objects are subjected to a governance process via a business model governance component 602. Business model governance component 602 can be realized by, for example, a human and/or automated workflow that traverses a governance policy as defined by the associated enterprise. In one example, a business application corresponding to respective business models authored via business model authoring component 602 are deemed approved if the respective models included in the application are approved. Once a business application is approved through the governance workflow, the application is ready for publication via a business model store 612. In one example, publishing an application implies that respective models included in the application consequentially become ready for implementation. Models can be implemented with one or more composite application components and can be related explicitly to identify the addressable resources that implement specific models. As shown by FIG. 6, business models that can be associated with business model store 612 include business object models (BOMs) 620, process models 622, tracking models 624, rules models 626, and/or any other suitable model type(s).

In one example, a BOM 620 can define respective business objects and vocabulary. A BOM 620 can also be associated with one or more related business objects, which are defined as a view on business objects. In an embodiment, BOM 620 can represent entities, events, and/or other suitable items. Events can include, e.g., business exceptions and/or other business events. Entities can be mapped to entity data model (EDM) entities, queries, or the like, while events can be mapped to, e.g., properties in an EDM entity. In one example, a BOM 620 can be used to abstract away implementations of events. For example, an implementation can be performed in any suitable manner, and subsequently the implementation can be plugged with the change notification for property. In another embodiment, a BOM 620 can be associated with out-of-box implementations for various tasks, such as e-mail, messaging, or the like.

In a further embodiment, BOM objects can be associated with fully-qualified type-names. Further, a given BOM 620 can have multiple implementations. In one example, an implementation of a BOM 620 is encapsulated by an application package with implemented types.

With further reference to tracking models 624, a tracking model 624 can include, e.g., an observation model, a trackpoint model, and/or one or more alerts. A trackpoint model can include, for example, process model collection points, computed trackpoints, and/or any other suitable point(s).

As further shown by FIG. 6, a developer can create an implementation for one or more models via a code development component 640. In one example, models are available to developers through various development tools for implementing business applications and models. For example, a model import component 642 can be utilized to import a model to code under development. Models can be exposed to a developer through, e.g., a business model browser 610, which obtains the models from business model store 612 and/or other sources. In an embodiment, developers are instructed to clearly identify the implementation resources that are responsible for implementing various models.

Upon completion of an implementation for a given business application, an implemented application 632 can be deployed via a deployment component 630 and/or stored via an application model store 634. In an embodiment, a model-implementation state management component 614 can be utilized to track relationships between models corresponding to an implemented application 632 and the implementation(s) utilized for the application.

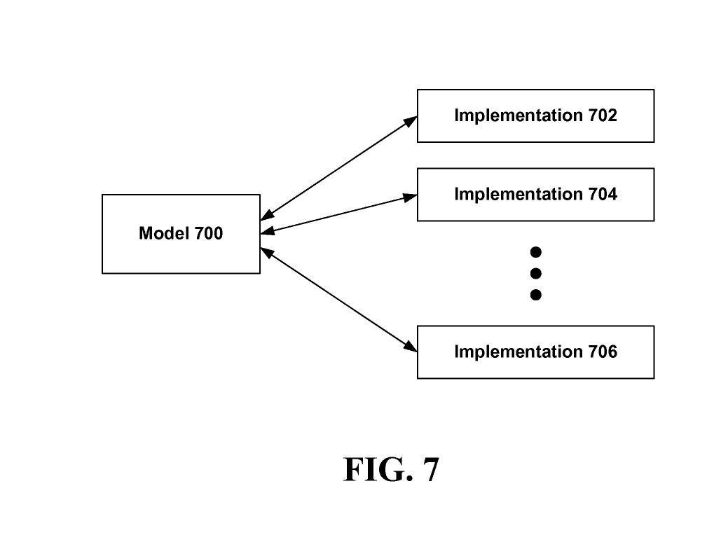

While the embodiments above have been described in the context of a one-to-one mapping between models and implementations, it can be appreciated that any suitable mapping relationship between models and their implementations can exist. For example, as shown by FIG. 7, a model 700 can be associated with multiple valid implementations 702-706. In the event that a model 700 has multiple valid implementations 702-706, associations can be maintained for the 1:N relationship between model 700 and its implementations 702-706, and an implementation can be selected for deployment from among the valid implementations 702-706. However, it can be appreciated that deployment of an implementation 702-706 for a given model can be restricted to only approved models 700.

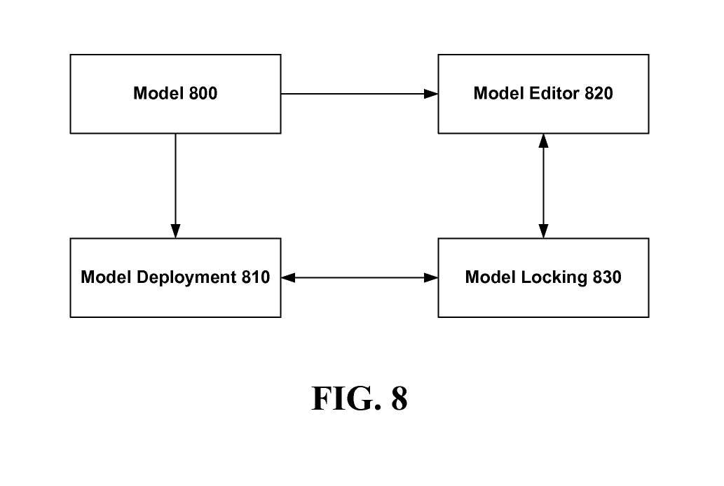

Turning next to FIG. 8, a business model editing management system is illustrated in accordance with one or more embodiments. In one example, an implemented application is considered complete when the models for the business application are implemented. Further, an implemented application can be restricted such that it is deployed upon approval of the corresponding models and completion of the implementation(s) for the models.

In an embodiment, deploying an implementation causes the corresponding model to be locked. Accordingly, as shown in FIG. 8, upon deployment of a model 800 by a model deployment component 810, a model locking component 830 can be utilized to lock editing of the model 800 (e.g., as conducted via a model editing component 820 and/or other suitable means) and place the model 800 in a read-only mode. While a model 800 is locked, other implementations of the model 800 can be created but the model 800 cannot be modified. When a model 800 is in a read-only state, changes to the model 800 are restricted to new copies and/or versions of the model 800. In one example, any modifications of the model 800 and/or new versions of the model 800 can be subjected to various governance and approval processes as generally described herein. In another example, if the implementation of the model 800 is undeployed, model locking component 830 can release the lock on the model 800 and allow editing of the model 800.

In general, it can be appreciated that the embodiments described herein provide a framework for defining and implementing business objects and other models such as process models, rules, KPIs, etc. The framework provided herein can also be used and extended for other kind of business models. The framework manages the lifecycle of a model and its implementation(s) and related states as described above. Further, the framework tracks changes and their potential impacts from model to implementation and vice versa. A business application model is defined by the framework herein as well as relationships between the business application model and its implementation model. Further, the lifecycle of business application models is managed in synchronization with an implemented application model lifecycle. In addition, a business object model is defined herein, which forms the basis for building business models and interactions with implementations.

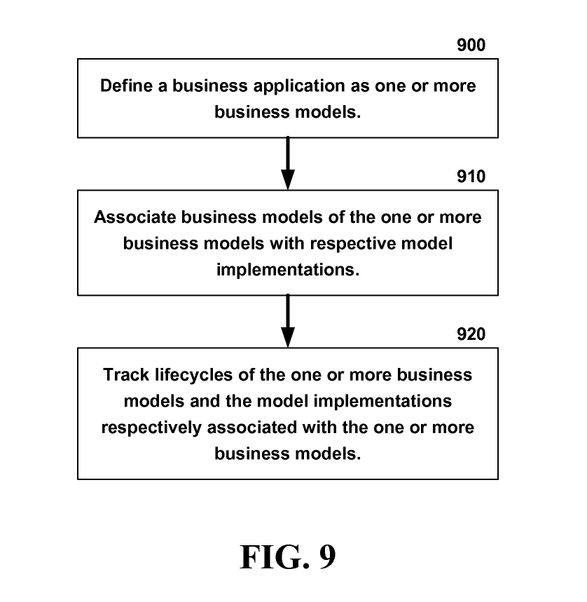

FIG. 9 is a flow diagram illustrating an exemplary non-limiting process for business application lifecycle management. At 900, a business application is defined as one or more business models. At 910, business models of the one or more business models are associated with respective model implementations. At 920, lifecycles of the one or more business models and the model implementations respectively associated with the one or more business models are tracked.

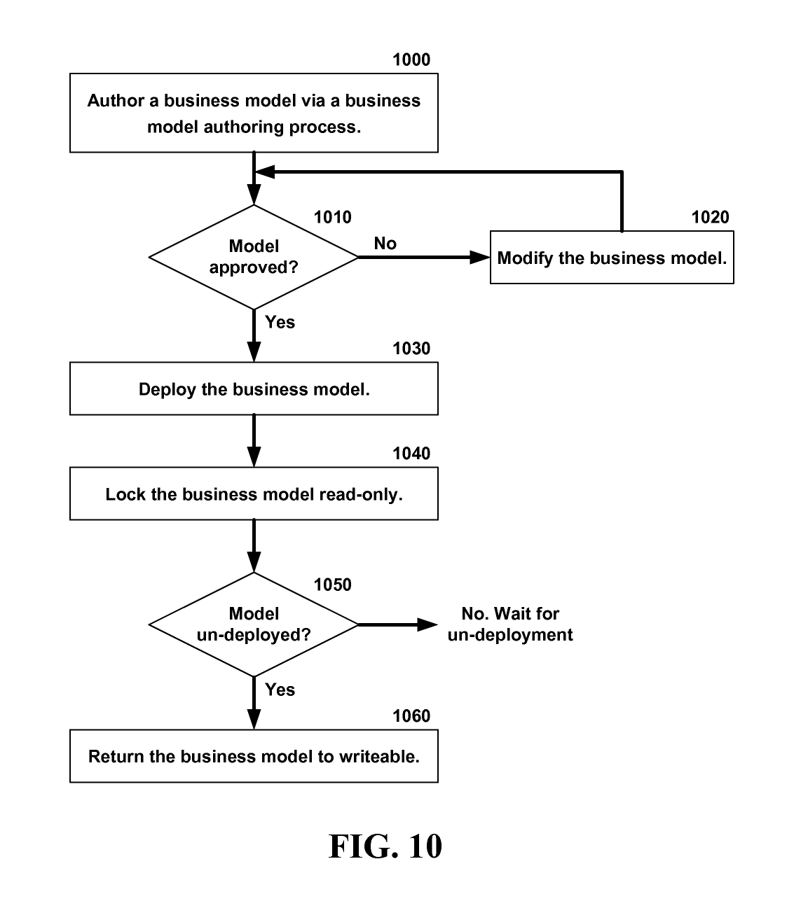

FIG. 10 is another flow diagram illustrating an exemplary non-limiting process for business model governance, deployment and editing control. At 1000, a business model is authored via a business model authoring process. At 1010, it is determined whether the model is approved. If the model is not approved, the model is modified at 1020 and the determination at 1010 is repeated. If the model is approved, the model is deployed at 1030. Next, at 1040, the model is locked read-only. At 1050, it is then determined whether the model has been un-deployed. If the model has not been un-deployed, the process waits for un-deployment. Otherwise, at 1060, the model is returned to writeable.

### Exemplary Networked and Distributed Environments

One of ordinary skill in the art can appreciate that the various embodiments of the lifecycle management systems and methods described herein can be implemented in connection with any computer or other client or server device, which can be deployed as part of a computer network or in a distributed computing environment. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the lifecycle management mechanisms as described for various embodiments of the subject disclosure.

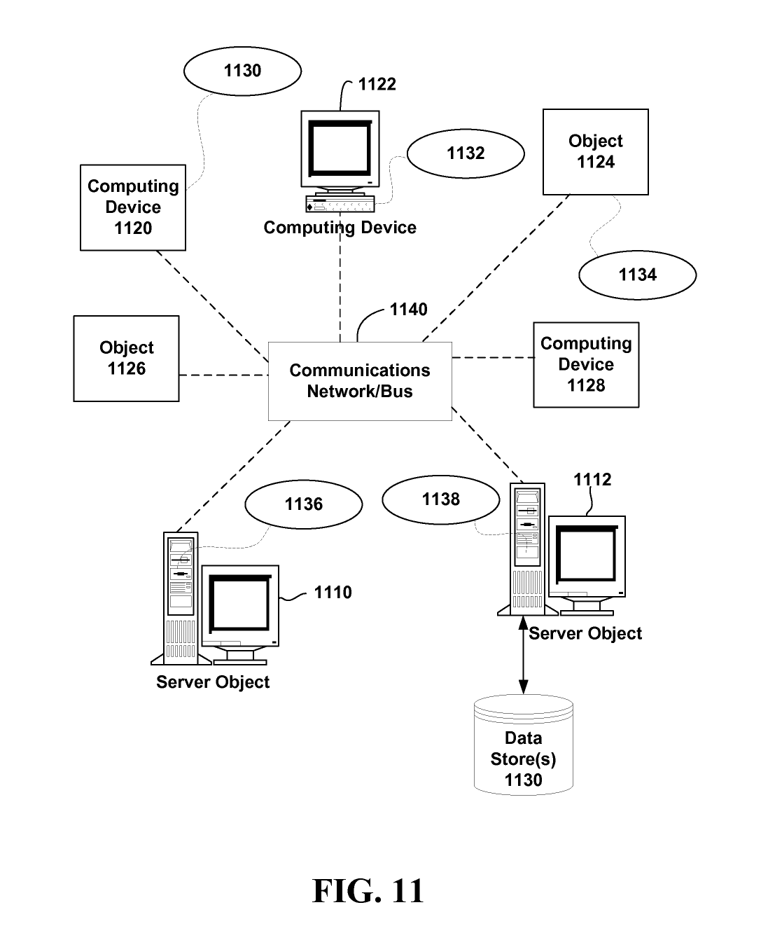

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that computing objects 1110, 1112, etc. and computing objects or devices 1120, 1122, 1124, 1126, 1128, etc. may comprise different devices, such as personal digital assistants (PDAs), audio/video devices, mobile phones, MP3 players, personal computers, laptops, etc.

Each computing object 1110, 1112, etc. and computing objects or devices 1120, 1122, 1124, 1126, 1128, etc. can communicate with one or more other computing objects 1110, 1112, etc. and computing objects or devices 1120, 1122, 1124, 1126, 1128, etc. by way of the communications network 1140, either directly or indirectly. Even though illustrated as a single element in FIG. 11, communications network 1140 may comprise other computing objects and computing devices that provide services to the system of FIG. 11, and/or may represent multiple interconnected networks, which are not shown. Each computing object 1110, 1112, etc. or computing object or device 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the scoping management techniques provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the lifecycle management systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 11, as a non-limiting example, computing objects or devices 1120, 1122, 1124, 1126, 1128, etc. can be thought of as clients and computing objects 1110, 1112, etc. can be thought of as servers where computing objects 1110, 1112, etc., acting as servers provide data services, such as receiving data from client computing objects or devices 1120, 1122, 1124, 1126, 1128, etc., storing of data, processing of data, transmitting data to client computing objects or devices 1120, 1122, 1124, 1126, 1128, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1140 or bus is the Internet, for example, the computing objects 1110, 1112, etc. can be Web servers with which other computing objects or devices 1120, 1122, 1124, 1126, 1128, etc. communicate via any of a number of known protocols, such as the hypertext transfer protocol (HTTP). Computing objects 1110, 1112, etc. acting as servers may also serve as clients, e.g., computing objects or devices 1120, 1122, 1124, 1126, 1128, etc., as may be characteristic of a distributed computing environment.

### Exemplary Computing Device

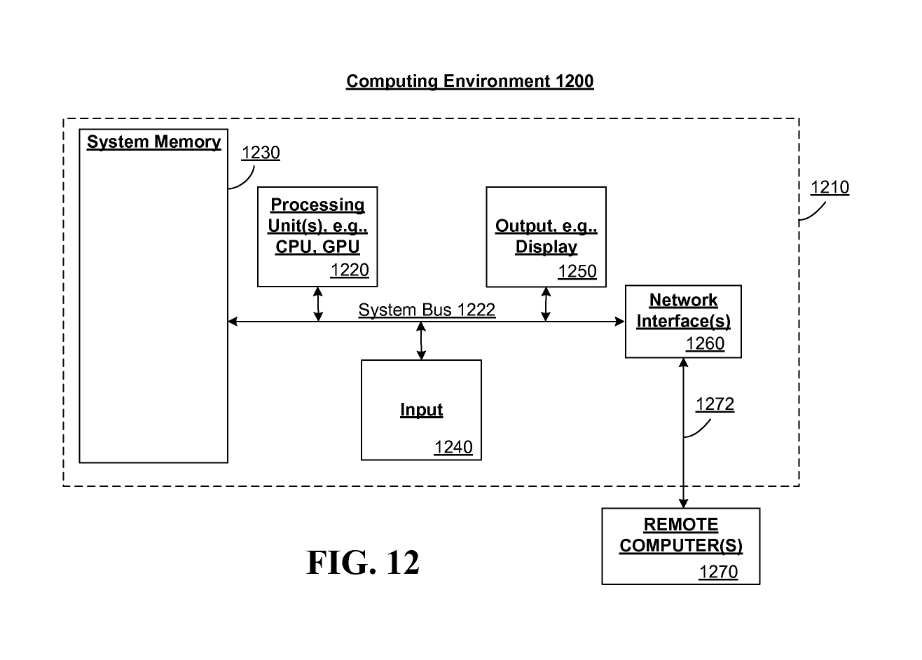

As mentioned, advantageously, the techniques described herein can be applied to any device where it is desirable to manage lifecycles of a business application associated with a computing system and its implementation(s). It can be understood, therefore, that handheld, portable and other computing devices and computing objects of all kinds are contemplated for use in connection with the various embodiments, i.e., anywhere that business applications may be utilized. Accordingly, the below general purpose remote computer described below in FIG. 12 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 12 thus illustrates an example of a suitable computing system environment 1200 in which one or aspects of the embodiments described herein can be implemented, although as made clear above, the computing system environment 1200 is only one example of a suitable computing environment and is not intended to suggest any limitation as to scope of use or functionality. Neither should the computing system environment 1200 be interpreted as having any dependency or requirement relating to any one or combination of components illustrated in the exemplary computing system environment 1200.

With reference to FIG. 12, an exemplary remote device for implementing one or more embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, system memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to manage lifecycles of a business application and its implementation(s).

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A business application lifecycle management system, comprising:
an application modeling component configured to facilitate construction of a business application as one or more business models; and
a lifecycle management component configured to associate the one or more business models with implementations of the one or more business models and to track lifecycles of the one or more business models and the implementations.

2. The system according to claim 1, wherein the application modeling component is further configured to facilitate construction of respective business models of the one or more business models as sets of artifacts.

3. The system according to claim 1, wherein the application modeling component comprises a business model creation component configured to construct the one or more business models and wherein the system further comprises an implementation creation component that facilitates creation of the respective implementations of the one or more business models.

4. The system according to claim 1, wherein the application modeling component comprises:
a business model authoring component configured to facilitate authoring of the one or more business models; and
a business model governance component configured to define an approval process for the one or more business models, wherein the one or more business models are deemed ready for deployment in response to approval.

5. The system according to claim 1, further comprising:
a business model store configured to store one or more approved business models.

6. The system according to claim 5, further comprising:
a business model browser configured to facilitate selection of one or more approved business models from the one or more approved business models stored by the business model store.

7. The system according to claim 6, further comprising:
a code development component configured to facilitate creation of code corresponding to an implementation of at least one approved business model; and
a model import component configured to facilitate importation of the at least one approved business model from the business model store.

8. The system according to claim 1, wherein the lifecycle management component comprises:
a model-implementation state management component configured to track lifecycle states with reference to relationships between a business model of the one or more business models and a deployed implementation for the business model of the one or more business models.

9. The system according to claim 1, further comprising:
an application model store configured to store data relating to at least one implemented business application.

10. The system according to claim 1, wherein at least one business model of the one or more business models is associated with a plurality of implementations and the lifecycle management component is configured to track lifecycle of at least one selected implementation corresponding to the at least one business model of the one or more business models.

11. The system according to claim 1, wherein the one or more business models comprise at least one of business object models (BOMs), process models, tracking models, or rules models.

12. The system according to claim 1, wherein a BOM represents at least one of entities or events.

13. The system according to claim 1, further comprising:
a model locking component configured to lock a business model to a read-only mode in response to deployment of the business model.

14. A method for managing lifecycle of a business application, comprising:
defining a business application as one or more business models;
associating business models of the one or more business models with model implementations; and
tracking lifecycles of the one or more business models and the model implementations associated with the one or more business models.

15. The method of claim 14, further comprising:
authoring respective business models of the one or more business models; and
approving the respective business models of the one or more business models for deployment via a governance process.

16. The method of claim 14, further comprising:
developing the model implementations respectively associated with the one or more business models; and
importing the one or more business models into the model implementations.

17. The method of claim 14, further comprising:
locking the one or more business models to a read-only state in response to deployment of the one or more business models.

18. The method of claim 17, further comprising:
returning the one or more business models to a writeable state in response to undeployment of the one or more business models.

19. The method of claim 14, wherein the tracking comprises:
identifying a plurality of model implementations associated with at least one business model of the one or more business models; and
tracking lifecycle of a selected model implementation from the plurality of model implementations.

20. A method for managing a business application lifecycle, comprising:
constructing a business application comprising one or more business models, the one or more business models respectively comprising at least one artifact;
identifying relationships between the one or more business models and implementations of the one or more business models; and
managing lifecycles of the one or more business models and the implementations of the one or more business models with reference to the relationships between the one or more business models and implementations of the one or more business models.
